(19) United States
(12) Patent Application Publication
(10) Pub. No.: US 2011/0194630 A1
(43) Pub. Date: Aug. 11, 2011

(54) SYSTEMS AND METHODS FOR REPORTING RADIO LINK FAILURE

(76) Inventors: Hua-Lung YANG, Taipei City (TW); Ren-Jr CHEN, Hsinchu City (TW); Chien-Min LEE, Taipei County (TW); Chun-Chia CHEN, Changhua County (TW)

(21) Appl. No.: 12/971,736

(22) Filed: Dec. 17, 2010

Related U.S. Application Data
(60) Provisional application No. 61/303,144, filed on Feb. 10, 2010.
(60) Provisional application No. 61/303,511, filed on Feb. 11, 2010.

(30) Foreign Application Priority Data
Sep. 7, 2010 (TW) 99130143

(51) Int. Cl. H04W 24/00; H04L 27/28

(52) U.S. Cl. 375/260; 370/242

(57) ABSTRACT

A mobile communications device is provided with a wireless module and a controller module. The wireless module receives a plurality of downlink signals from a service node and determines a plurality of status indicators respectively corresponding to the downlink signals. The controller module determines whether a radio link failure has occurred according to the status indicators, and transmits at least one uplink signal via the wireless module to indicate information of the radio link failure to the service node in response to the occurrence of the radio link failure.

### CROSS REFERENCE TO RELATED APPLICATIONS

This application claims the benefit of U.S. Provisional Application No. 61/303,144, filed on Feb. 10, 2010, the entirety of which is incorporated by reference herein. This application also claims the benefit of U.S. Provisional Application No. 61/303,511, filed on Feb. 11, 2010, the entirety of which is incorporated by reference herein. This application further claims priority of Taiwan Patent Application No. 99130143, filed on Sep. 7, 2010, the entirety of which is incorporated by reference herein.

### BACKGROUND OF THE INVENTION

1. Field

The invention generally relates to Radio Link Failure (RLF) controls and, more particularly, to RLF reporting mechanisms for mobile communications devices.

2. Description of the Related Art

Due to mobile communication technology advancements in recent years, various communication services, such as voice call services, data transfer services, and video call services, etc., may be provided to users regardless of their locations. Most mobile communications systems are multiple access systems in which access and wireless network resources are allocated to multiple users. The multiple access technologies employed by the mobile communications systems include the 1× Code Division Multiple Access 2000 (1× CDMA 2000) technology, the 1× Evolution-Data Optimized (1× EVDO) technology, the Orthogonal Frequency Division Multiplexing (OFDM) technology, and the Long Term Evolution (LTE) technology. In order to obtain the wireless network resource, a mobile communications device of a user, or so-called a user equipment (UE), has to perform a specific attachment procedure to connect to a service node of a mobile communications system, so that the service node allocates proper downlink and uplink channels (generally referred to as a radio link) for the UE to communicate with. However, in some cases, attenuation of the signal quality of the downlink and uplink channels may occur and cause an RLF. For example, an RLF may occur in the case where a UE leaves the coverage of a camped service node and enters an area without any service node coverage (e.g. a tunnel or basement).

FIG. 1 is a block diagram illustrating the RLF operations in an LTE Release 8 mobile communications device. At first, when detecting that a Signal to Interference and Noise Ratio (SINR) of received wireless signals has fallen below a threshold, the physical layer may issue an out-of-sync indication to the upper layer. Later, the upper layer starts the timer T1 with a timing interval (denoted as T310), when the number of the received out-of-sync indications reaches N310. If no in-sync indication is received before the timer T1 expires, the upper layer determines that an RLF has occurred. Otherwise, if an in-sync indication is received before the timer T1 expires, the upper layer resumes normal operations performed before the occurrence of the RLF. Subsequently, the upper layer starts another timer T2 and waits for recovery to the connected mode (denoted as “RRC_CONNECTED”), upon determining the occurrence of the RLF. If no in-sync indication is received before the timer T2 expires, the upper layer performs a radio link release procedure to enter the idle mode (denoted as “RRC_IDLE”) from the connected mode.

FIG. 2 is a block diagram illustrating an RLF in a multi-carrier LTE system. In such an LTE system, the mobile communications device 21 receives wireless signals and/or data from the evolved Node-B (eNB) 22 via 5 downlink Component Carriers (CC), wherein different CCs may be used to carry different type of data or multiple CCs may be used to carry the same type of data. For example, CC#0 may be used to carry voice call data, CC#1 and CC#2 may be used to carry File Transfer Protocol (FTP) data, and CC#3 and CC#4 may be used to carry video call data; or alternatively, all of CC#0, CC#1, CC#2, CC#3, and CC#4 may be used to carry voice call data, FTP data, or video call data. It is noted that, in this example, an RLF has occurred in CC#4 so the mobile communications device 21 is unable to receive the data carried by CC#4. However, the eNB 22 is unaware that the RLF has occurred in CC#4 and keeps transmitting data to the mobile communications device 21 via CC#4. As a result, network resources associated with CC#4 are wasted, and the data carried by CC#4 is unsuccessfully transmitted, which may cause service disruptions for the mobile communications device 21.

### SUMMARY

In one embodiment of the invention, a mobile communications device is provided. The mobile communications device comprises a wireless module and a controller module. The wireless module receives a plurality of downlink signals from a service node and determines a plurality of status indicators respectively corresponding to the downlink signals. The controller module determines whether an RLF has occurred according to the status indicators, and transmits at least one uplink signal via the wireless module to indicate information of the RLF to the service node in response to the occurrence of the RLF.

In another embodiment of the invention, an RLF reporting method for a mobile communications device supporting multiple component carriers is provided. The RLF reporting method comprises the steps of receiving a plurality of downlink signals from a service node, determining a plurality of status indicators respectively corresponding to the downlink signals, determining whether a radio link failure has occurred according to the status indicators, and transmitting at least one uplink signal to indicate information of the radio link failure to the service node in response to the occurrence of the radio link failure.

Other aspects and features of the present invention will become apparent to those with ordinarily skilled in the art upon review of the following description of specific embodiments of the apparatus and methods for reporting RLF.

### BRIEF DESCRIPTION OF DRAWINGS

The invention can be more fully understood by reading the subsequent detailed description and examples with references made to the accompanying drawings, wherein:

FIG. 1 is a block diagram illustrating the RLF operations in an LTE Release 8 mobile communications device;

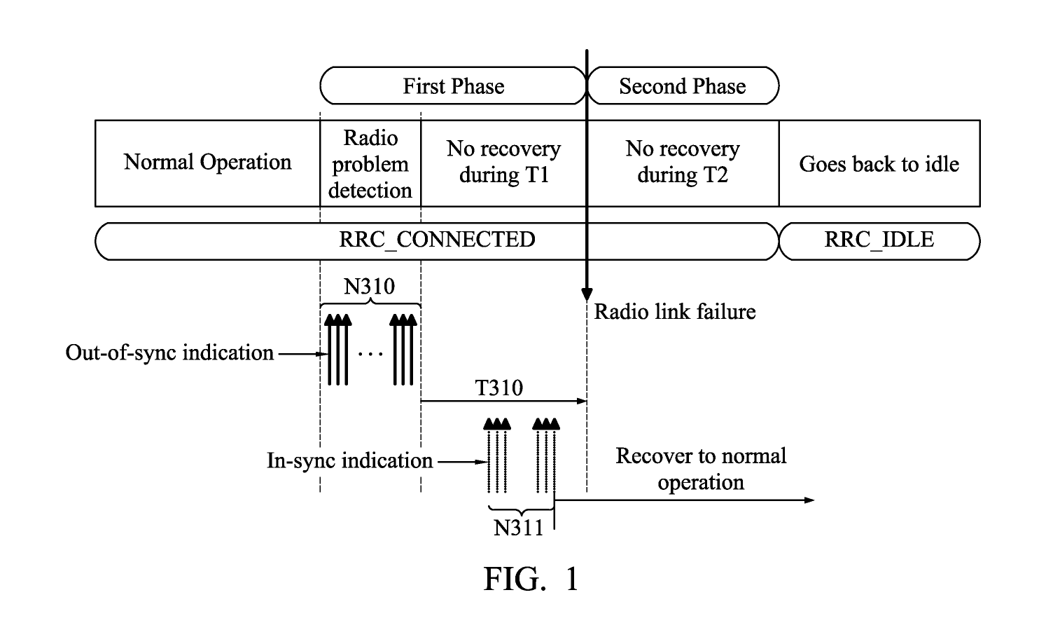

FIG. 2 is a block diagram illustrating an RLF in a multi-carrier LTE system;

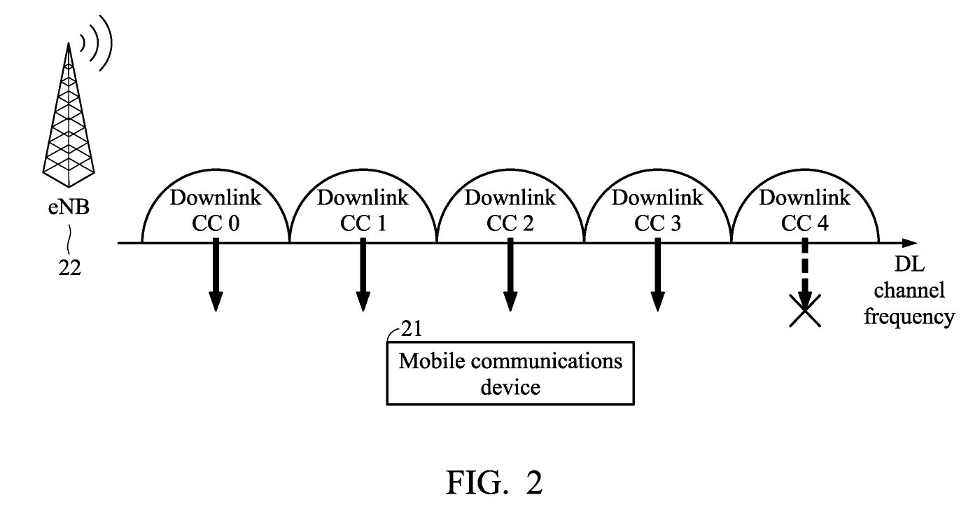

FIG. 3 is a block diagram illustrating a mobile communications device according to an embodiment of the invention;

FIG. 4 is a block diagram illustrating an RLF report via the Physical Uplink Share Channel (PUSCH) according to an embodiment of the invention;

FIG. 5 is a block diagram illustrating the multiplexing and channel interleaving operations on the data to be transmitted via the PUSCH according to an embodiment of the invention;

FIG. 6 is a block diagram illustrating an exemplary data arrangement after the multiplexing and channel interleaving operations according to an embodiment of the invention;

FIG. 7 is a block diagram illustrating a subframe of an uplink CC according to an embodiment of the invention;

FIG. 8A is a block diagram illustrating an RLF report via the PUCCH according to an embodiment of the invention;

FIG. 8B is a block diagram illustrating an RLF report via the PUCCH according to another embodiment of the invention;

FIG. 9 is a block diagram illustrating an RLF report via the PUCCH according to still another embodiment of the invention;

FIG. 10 is a block diagram illustrating an RLF report via a Sounding Reference Signal (SRS) according to still another embodiment of the invention;

FIG. 11 is a block diagram illustrating a Coordinated Multi-Point transmission/reception (CoMP) network according to an embodiment of the invention; and

FIG. 12 is a flow chart illustrating the RLF reporting method according to an embodiment of the invention.

### DETAILED DESCRIPTION OF THE EMBODIMENTS

The following description is of the best-contemplated mode of carrying out the invention. This description is made for the purpose of illustrating the general principles of the invention and should not be taken in a limiting sense. The scope of the invention is best determined by reference to the appended claims.

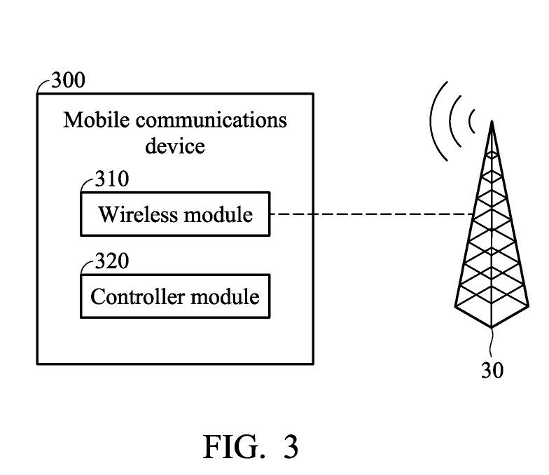

The invention provides methods for mobile communications devices supporting multiple carriers to report the occurrence of RLF to the service node, so that the service node may be informed about the RLF and accordingly adjust allocated wireless network resources. FIG. 3 is a block diagram illustrating a mobile communications device according to an embodiment of the invention. The mobile communications device 300 comprises the wireless module 310 and the controller module 320. The wireless module 310 provides wireless communications to and from the service node 30. Specifically, the wireless module 310 receives a plurality of downlink signals from the service node 30, and then determines a plurality of status indicators respectively corresponding to the downlink signals. The controller module 320 determines whether an RLF has occurred according to the status indicators, and if so, transmits at least one uplink signal via the wireless module 310 to indicate the information of the RLF to the service node 30. In one embodiment, the status indicators may be the SINR of the downlink signals. When the SINR of the downlink signals are lower than a threshold, the wireless module 310 may issue to the controller module 320 an out-of-sync indication, whereafter the controller module 320 may determine whether an RLF has occurred. To further clarify, the downlink signals are received on a plurality of CCs, respectively, and the controller module 320 may determine which one or more of the CCs that the RLF has occurred on (or referred to herein as the malfunctioned CC(s)). After that, the controller module 320 further requests the wireless module 310 to stop monitoring the malfunctioned CC(s), so that power consumption may be saved. Meanwhile, the service node 30 may obtain the RLF information according to the received uplink signal, and further suspend the data transceiving on the malfunctioned CC(s). The suspended data may be dispatched to be transmitted on other functioning CCs.

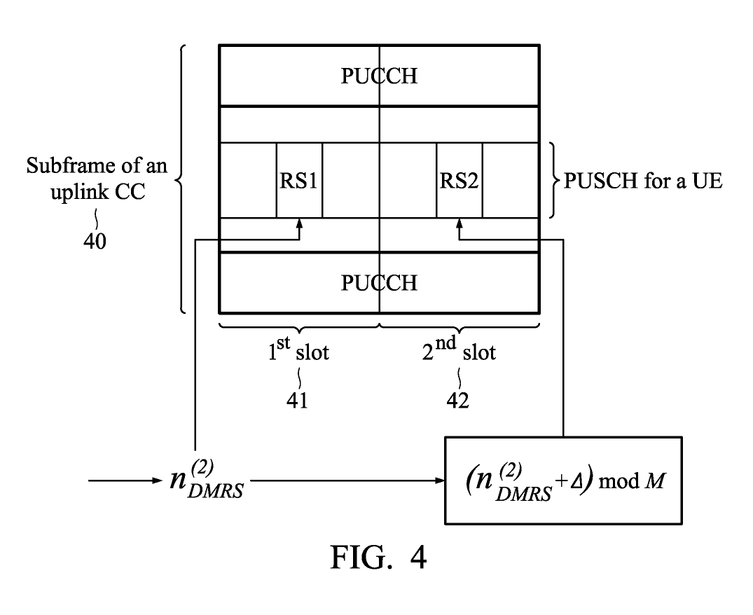

FIG. 4 is a block diagram illustrating an RLF report via the PUSCH according to an embodiment of the invention. As shown in FIG. 4, in the time domain, the subframe 40 of an uplink CC may be divided into two slots 41 and 42, and in the frequency domain, the subframe 40 may be divided into a PUSCH for carrying user data and a Physical Uplink Control CHannel (PUCCH) for carrying control data for a user. In the PUCCH, the reference signals RS1 and RS2 for the user are to be transmitted in the slots 41 and 42, respectively, wherein the reference signals RS1 and RS2 are generated by the controller module 320 using difference Cyclic Shift (CS) parameters (denoted as n_{DMRS}⁽²⁾ and (n_{DMRS}⁽²⁾+Δ)mod M). When receiving the reference signals RS1 and RS2, the service node 30 may obtain the information of the RLF according to the difference between the CS parameters used in the reference signals RS1 and RS2. In this embodiment, the controller module 320 uses the CS parameter, n_{DMRS}⁽²⁾, for the reference signal RS1 according to the 3GPP specification of the LTE system (herein referred to as the specification TS36.211 v.910). For the reference signal RS2, the controller module 320 adds a CS difference Δ to n_{DMRS}⁽²⁾ and uses the adjusted CS parameter (n_{DMRS}⁽²⁾+Δ)mod M for the generation of the reference signal, wherein M represents the margin for CS. Reference may be made to the specification TS36.211 v.910 for the detailed descriptions regarding the derivation of n_{DMRS}⁽²⁾ and the generation of the reference signals according to the CS parameters, and thus, is omitted here as it is beyond the scope of the invention. In one embodiment, it is assumed that the value of M is 8 and the CS parameter for the reference signal RS1 is 6. Subsequently, the controller module 320 may determine the CS difference Δ according to the malfunctioned CC. For example, if the RLF has occurred on CC#1, the CS difference Δ may be set to 1, i.e., the CS parameter for the reference signal RS2 is 7 (6+1 mod 8=7). Thus, the service node 30 may determine the malfunctioned CC according to the difference between the CS parameters used for the reference signals RS1 and RS2. An exemplary mapping relationship between the CS difference Δ and the malfunctioned CC is given below in Table 1.

TABLE 1

| CS difference (Δ) | indication |
|---|---|
| 0 | No RLF |
| 1 | RLF occurred in CC#0 |
| 2 | RLF occurred in CC#1 |
| 3 | RLF occurred in CC#2 |
| 4 | RLF occurred in CC#3 |
| 5 | RLF occurred in CC#4 |
| others | reserved |

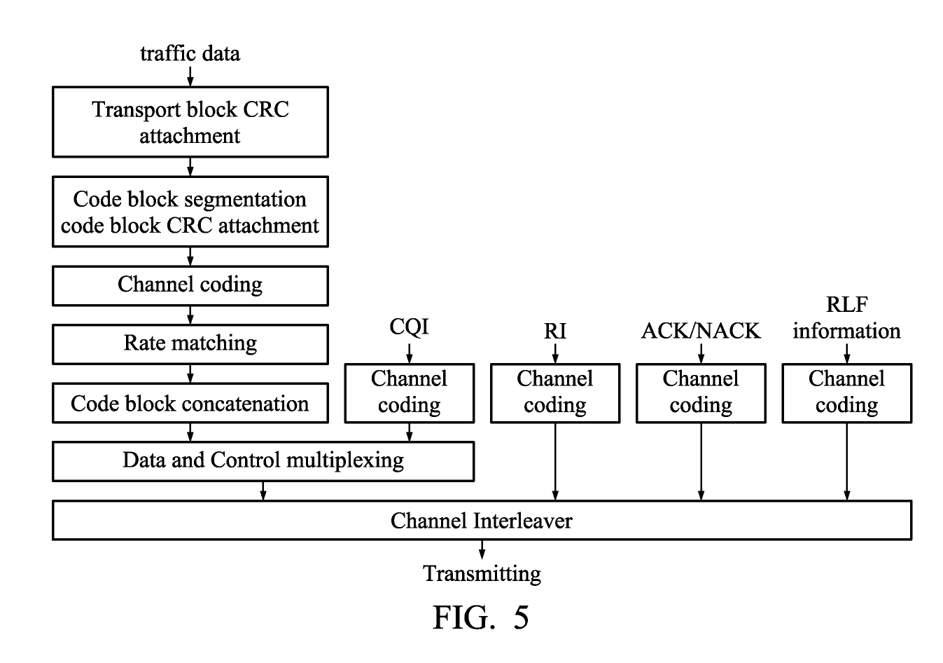

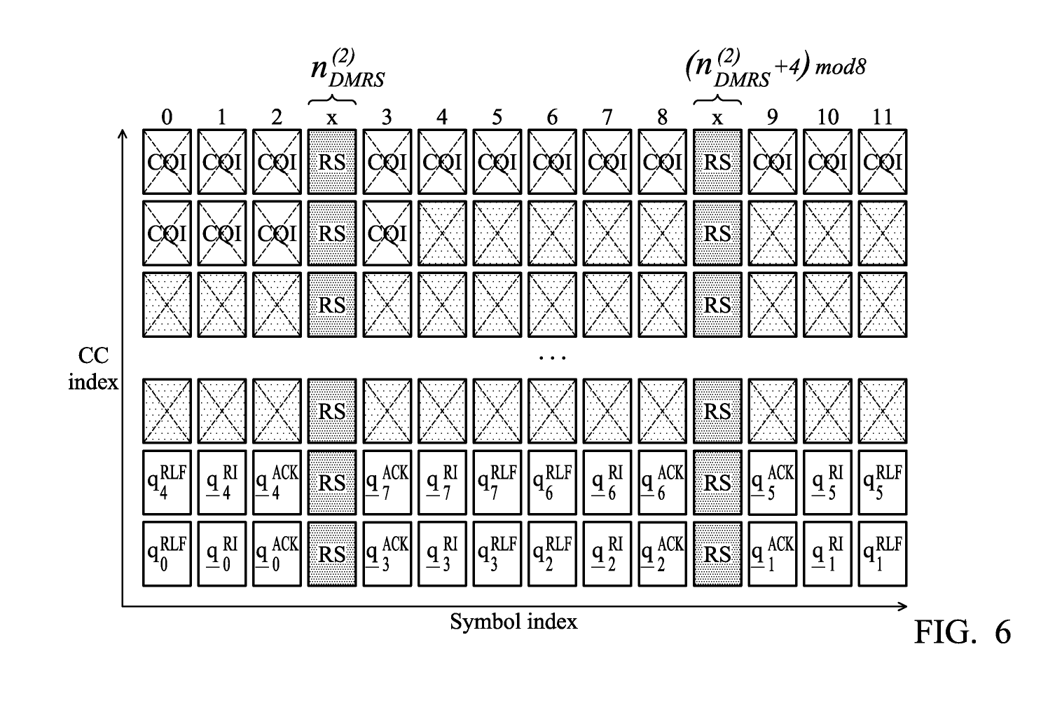

In another embodiment, a two-staged mechanism may be employed to generate the information of the RLF. For the reference signal RS1, the controller module 320 uses the CS parameter, n_{DMRS}⁽²⁾, according to the specification TS36.211 v.910, while for the reference signal RS2, the controller module 320 uses a fixed CS difference Δ to adjust the CS parameter instead of using the CS difference Δ according to the malfunctioned CC as described with respect to Table 1. That is, in the first stage, the controller module 320 uses the same CS difference Δ to generate the reference signal RS2 regardless of which CC the RLF has occurred on. For example, the CS difference Δ may be set to a fixed value of 4. Subsequently, in the second stage, the controller module 320 performs multiplexing and channel interleaving operations on the information of the RLF, the traffic data, and the control data, as shown in FIG. 5. The traffic data may be referred to as the user data which is generally the data concerning the service in use by the user. The control data may comprise information concerning the Channel Quality Indicator (CQI), Rank Indicator (RI), and acknowledgement/negative-acknowledgement (ACK/NACK). FIG. 6 is a block diagram illustrating an exemplary data arrangement after the multiplexing and channel interleaving operations according to an embodiment of the invention. As shown in FIG. 6, the symbols carrying the information of the RLF are denoted as q^{RLF}, the symbols carrying the CQI are denoted as CQI, the symbols carrying the RI are denoted as q^{RI}, the symbols carrying the ACK/NACK are denoted as q^{ACK} or q^{NACK}, and the symbols carrying the traffic data are denoted as the blocks with cross-out marks. Note that the symbols carrying the information of the RLF are selected from the symbols originally allocated for carrying the traffic data. Therefore, the service node 30 may first determine whether an RLF has occurred on any CC according to the reference signals RS1 and RS2, and if so, further obtain the information of the malfunctioned CC from the symbols carrying the information of the RLF. It is to be understood that the CS difference Δ may be set to any value other than 4 and the symbols selected for carrying the information of the RLF are not limited to those shown in FIG. 6, without departing from the spirit of the invention.

In yet another embodiment, the two-staged mechanism as described in FIG. 5 and FIG. 6 may be employed to indicate information other than the RLF. Specifically, in the first stage, the controller module 320 determines the CS difference Δ according to the type of the to-be-indicated information. An exemplary mapping relationship between the CS difference Δ and the to-be-indicated information is given below in Table 2.

TABLE 2

| CS difference (Δ) | To-be-indicated information |
|---|---|
| 0 | Single-node transmission information |
| 1 | Multi-node transmission information |
| 2 | Multi-band related information |
| 3 | measurement information for multi-band |
| 4 | RLF information |
| 5 | Multiple-Input and Multiple-Output (MIMO) |
| | channel information |
| others | reserved |

The single-node transmission refers to the transmission mode between the mobile communications device 300 and the service node 30 as being one-on-one, while the multi-node transmission refers to the transmission mode between the mobile communications device 300 and the service node 30 as being many-to-one. Each of the single-node transmission information and the multi-node transmission information comprises the CQI, Pre-coding Matrix Indicator (PMI), RI, and other information. The MIMO channel information comprises information concerning the covariance matrix of the MIMO channel(s). Later, in the second stage, the controller module 320 performs multiplexing and channel interleaving operations on the to-be-indicated information, the traffic data, and the control data for the PUSCH, as shown in FIG. 5. The symbols carrying the to-be-indicated information may be selected from the symbols originally allocated for carrying the traffic data, as shown in FIG. 6, but the selected symbols are not limited thereto.

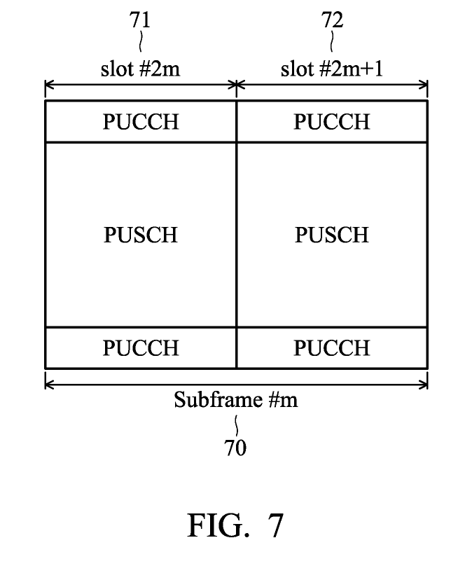

Note that the PUSCH is allocated by the service node 30 to the mobile communications device 300 for transmitting uplink signals. However, there may be situations where the service node 30 may not allocate the PUSCH to the mobile communications device 300. In such situations, the controller module 320 may alternatively use the PUCCH to report the information of the RLF to the service node 30. FIG. 7 is a block diagram illustrating a subframe of an uplink CC according to an embodiment of the invention. As shown in FIG. 7, in the time domain, the subframe 70 may be divided into two slots 71 and 72, and in the frequency domain, the subframe 70 may be divided into a PUSCH for carrying user data and a PUCCH for carrying control data.

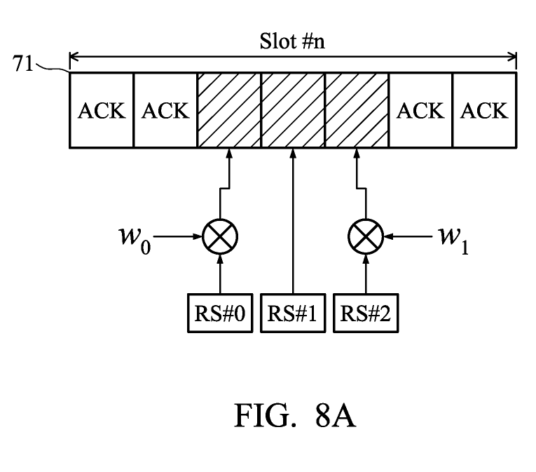

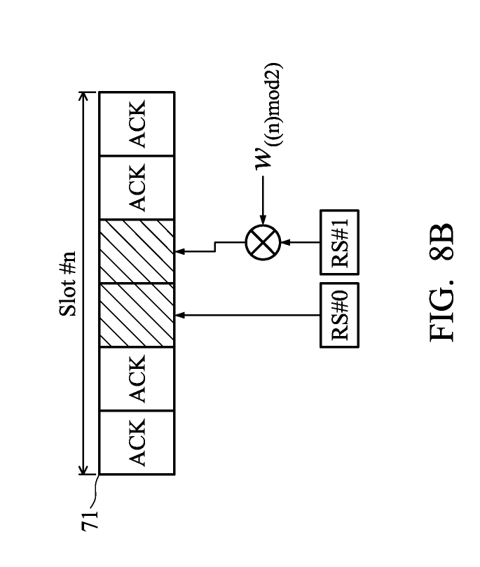

FIG. 8A is a block diagram illustrating an RLF report via the PUCCH according to an embodiment of the invention. In this embodiment, a Normal Cyclic Prefix (NCP) architecture is employed for the PUCCH. As shown in FIG. 8A, the slot 71 includes 7 OFDM symbols, wherein 4 OFDM symbols are used for carrying ACK/NACK information and the other 3 OFDM symbols are used for carrying the reference signals RS#0, RS#1, and RS#2, respectively. In order to report the RLF, the controller module 320 rotates the reference signals RS#0 and RS#2 for phases w₀ and w₁, respectively, and no phase rotation is performed on the reference signal RS#1. In one embodiment, the phases w₀ and w₁ are determined by

$${W}_{i} ∈ \{ 1 , {e}^{\frac{j2π}{3}} , {e}^{\frac{j4π}{3}} \} , i ∈ \{ 0 , 1 \} .$$

When receiving the subframe 70 on the PUCCH, the service node 30 obtains the phases w₀ and w₁ from the reference signals RS#0 and RS#2 in the slot 71, and determines the information of the RLF according to the phases w₀ and w₁. An exemplary mapping relationship between the phases w₀ and w₁ and the information of the RLF is given below in Table 3.

TABLE 3

| Phase w₀ | Phase w₁ | Information of the RLF |
|---|---|---|
| 1 | 1 | No RLF |
| 1 | e^{j2π/3} | RLF occurred in CC#0 |
| 1 | e^{j4π/3} | RLF occurred in CC#1 |
| e^{j2π/3} | 1 | RLF occurred in CC#2 |
| e^{j2π/3} | e^{j2π/3} | RLF occurred in CC#3 |
| e^{j2π/3} | e^{j4π/3} | RLF occurred in CC#4 |
| e^{j4π/3} | 1 | reserved |
| e^{j4π/3} | e^{j2π/3} | reserved |
| e^{j4π/3} | e^{j4π/3} | reserved |

Accordingly, the mobile communications device 300 may select a proper pair of the phases w₀ and w₁ from the mapping relationship to indicate the malfunctioned CC. Similarly, the service node 30 obtains the information of the RLF according to the mapping relationship and the phases w₀ and w₁.

FIG. 8B is a block diagram illustrating an RLF report via the PUCCH according to another embodiment of the invention. In this embodiment, a Extended Cyclic Prefix (ECP) architecture is employed for the PUCCH. As shown in FIG. 8B, the slot 71 includes 6 OFDM symbols, wherein 4 OFDM symbols are used for carrying ACK/NACK information and the other 2 OFDM symbols are used for carrying the reference signals RS#0 and RS#1, respectively. In order to report the RLF, the reference signal RS#1 is rotated for a phase w_{(n mod 2)} and no phase rotation is performed on the reference signal RS#0, and the reference signals in the slot 72 is configured in the same way. Taking the subframe in FIG. 7 for example, the indices of the slots 71 and 72 are 2m and 2m+1, respectively. The reference signals RS#1 in the slots 71 and 72 are rotated for phases w₀ and w₁, respectively, while the reference signals RS#0 in the slots 71 and 72 stay un-rotated, wherein the phases w₀ and w₁ are determined by

$${W}_{i} ∈ \{ 1 , {e}^{\frac{j2π}{3}} , {e}^{\frac{j4π}{3}} \} , i ∈ \{ 0 , 1 \} .$$

When receiving the subframe 70 from the PUCCH, the service node 30 obtains the phases w₀ and w₁ and determines the information of the RLF according to the phases w₀ and w₁.

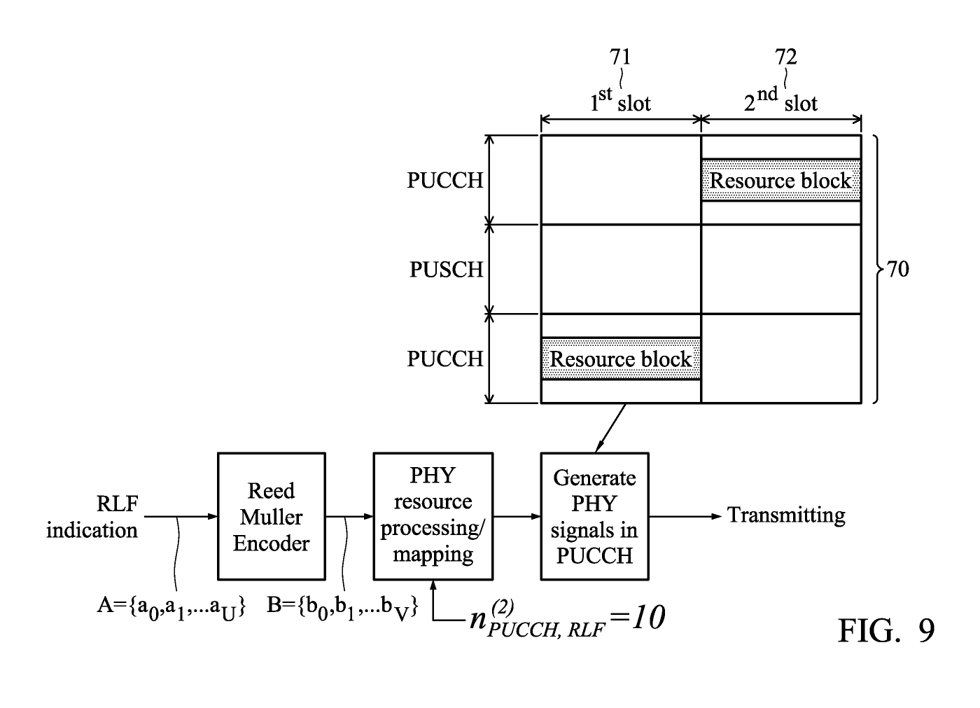

FIG. 9 is a block diagram illustrating an RLF report via the PUCCH according to still another embodiment of the invention. Similar to FIGS. 8A and 8B, the controller module 320 may alternatively use the PUCCH to report the RLF when no PUSCH is allocated by the service node 30. Yet, different from FIGS. 8A and 8B, in this embodiment, the information of the RLF is encoded in the same way as the control data (such as the ACK/NACK information, scheduling requests of uplink resources transmission, CQI, PMI, and RI, etc.), and further transmitted on the PUCCH. As shown in FIG. 9, the information of the RLF, denoted as A={a₀, a₁, . . . , a_{U}}, is encoded using the Reed Muller Encoder, and resource processing/mapping is performed on the encoded result, denoted as B={b₀, b₁, . . . , b_{V}}, according to the resource index n_{PUCCH,RLF}⁽²⁾ configured by the upper layers to generate the resource blocks to be transmitted on the PUCCH. Reference may be made to the specifications TS36.211 v.910 and TS36.212 v.910 for the detailed description regarding the operations of the Reed Muller Encoder and the configuration of the resource index n_{PUCCH,RLF}⁽²⁾, and thus, is omitted here as it is beyond the scope of the invention. Next, the generated resource blocks are transmitted in difference frequencies within the slots 71 and 72, as shown in FIG. 9, so that when delivery of the resource block transmitted in the frequency within one slot to the service node 30 fails due to bad signal conditions, the service node 30 may still receive the control data from the resource block transmitted in the frequency within another slot and then obtain the information of the RLF from the control data. In one embodiment, 3 bits may be used to indicate the CC on which the RLF has occurred, as shown below in Table 4.

TABLE 4

| A = {a₀, a₁, a₂} | indication |
|---|---|
| 000 | RLF occurred in CC#0 |
| 001 | RLF occurred in CC#1 |
| 010 | RLF occurred in CC#2 |
| 011 | RLF occurred in CC#3 |
| 100 | RLF occurred in CC#4 |
| others | reserved |

In another embodiment, 5 bits may be used to indicate the CC on which the RLF has occurred, as shown below in Table 5.

TABLE 5

| A = {a₀, a₁, a₂, a₃, a₄} | indication |
|---|---|
| 10000 | RLF occurred in CC#0 |
| 01000 | RLF occurred in CC#1 |
| 00100 | RLF occurred in CC#2 |
| 00010 | RLF occurred in CC#3 |
| 00001 | RLF occurred in CC#4 |
| others | reserved |

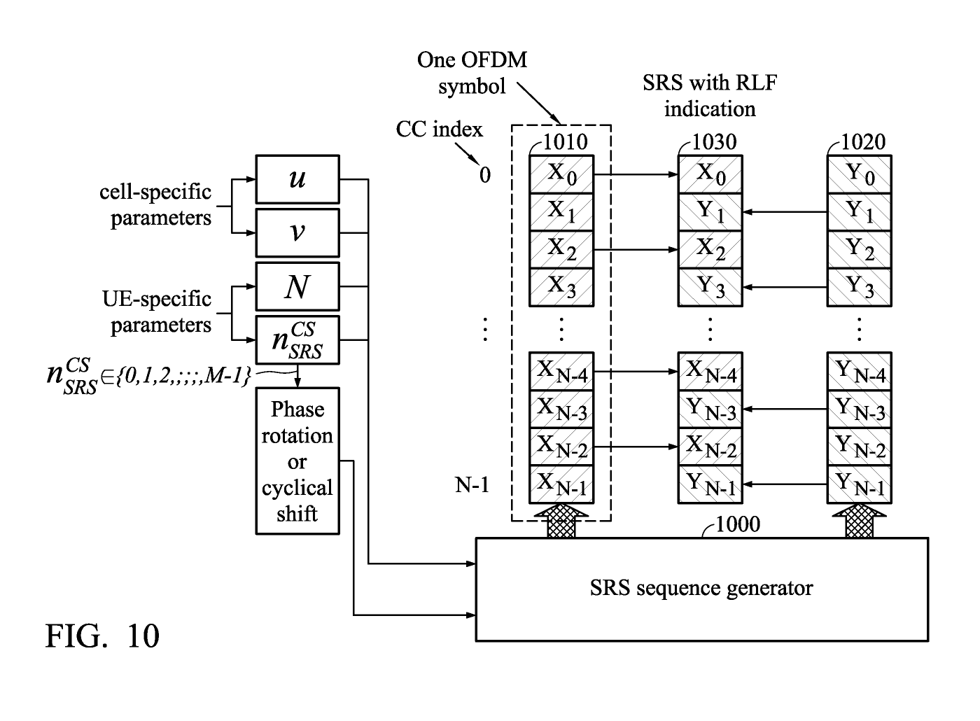

FIG. 10 is a block diagram illustrating an RLF report via an SRS according to still another embodiment of the invention. In addition to the PUSCH and the PUCCH, the uplink channels also comprises the SRS which is generally used as a way for the service node 30 to measure the signal quality of the uplink channel from the mobile communications device 300. The SRS may be transmitted via a single OFDM symbol or multiple OFDM symbols. Taking the LTE system for example, in this embodiment, the mobile communications device 300 uses the cell-specific parameters u and v, and the UE-specific parameters N and n_{SRS}^{CS} to generate the signal sequence of an SRS, wherein the UE-specific parameter n_{SRS}^{CS} represents a CS value out of M possible values (i.e. n_{SRS}^{CS}ε{0, 1, 2, . . . , M−1}). Firstly, the SRS sequence generator 1000 generates the signal sequence 1010 of an SRS using the cell-specific parameters and the UE-specific parameters. Secondly, the UE-specific parameter n_{SRS}^{CS} is phase-rotated or cyclically shifted, and the SRS sequence generator 1000 generates the signal sequence 1020 of the SRS using the cell-specific parameters u and v, the UE-specific parameter M, and the phase-rotated or cyclically shifted UE-specific parameter n_{SRS}^{CS}. Thirdly, the signal sequence 1030 is generated by replacing specific sequence elements in the signal sequence 1010 with the corresponding sequence elements in the signal sequence 1020. Lastly, the mobile communications device transmits the signal sequence 1030 to the service node 30. As shown in FIG. 10, the even-indexed sequence elements in the signal sequence 1020 are selected to replace the even-indexed sequence elements in the signal sequence 1010. Alternatively, the odd-indexed sequence elements in the signal sequence 1020 are selected to replace the odd-indexed sequence elements in the signal sequence 1010, or the signal sequence 1010 is replaced with the signal sequence 1020. To further clarify, for the cyclical shift, the controller module 320 may leave the UE-specific parameter n_{SRS}^{CS} unchanged

$$( i . e . {\tilde{n}}_{SRS}^{CS} = {n}_{SRS}^{CS} ) ,$$

and set a CS difference Δ_{\tilde{R}LF}=Δ. The CS difference may be used to indicate the information of the RLF, as described with respect to Table 1. For the phase rotation, the controller module 320 may set the CS difference to 0 (i.e. Δ_{\tilde{R}LF}=0), and rotates the UE-specific parameter n_{SRS}^{CS} for a specific phase as follows:

$${\overline{n}}_{SRS}^{CS} = ( {n}_{SRS}^{CS} + Δ ) mod M$$

, wherein the specific phase may be used to indicate the information of the RLF, as described with respect to Table 3. Next, the SRS sequence generator 1000 generates the signal sequence of an SRS according to the following equations:

$${r}^{SRS} ( n ) = {r}_{u , v}^{( α )} ( n ) , 0 \leq n \leq N$$

$${r}_{u , v}^{( α )} ( n ) = {\overline{r}}_{u , v} ( n ) \cdot {e}^{j2π {\tilde{n}}_{SRS}^{CS} / M}$$

$${\overline{r}}_{u , v} ( n ) = {x}_{q} ( ( n + {\tilde{Δ}}_{RLF} ) mod {N}_{ZC}^{RS} )$$

$${x}_{q} ( m ) = {e}^{- j \frac{π qm ( m + 1 )}{{N}_{ZC}^{RS}}}$$

$$q = ⌊ \overline{q} + \frac{1}{2} ⌋ + v \cdot {( - 1 )}^{⌊ 2 \overline{q} ⌋}$$

$$\overline{q} = {N}_{ZC}^{RS} \cdot ( u + 1 ) / 31$$

wherein N_{ZC}^{RS} represents the length of the Zadoff-Chu sequence and its value is the maximum prime satisfying N_{ZC}^{RS}<N. When receiving the SRS, the service node 30 may obtain the information of the RLF according to the CS difference or rotated phase.

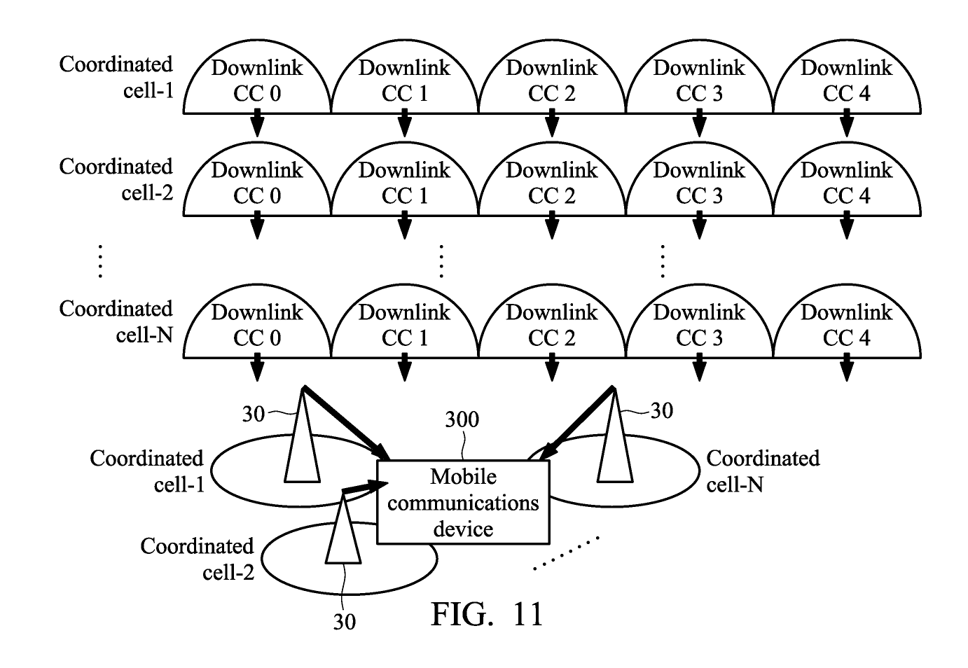

The service node 30 may be an eNB, a HeNB, a femtocell, a relay station, a plurality of coordinated cells, or a heterogeneous network comprising any of the above. In one embodiment, the service node 30 may be a CoMP network, as shown in FIG. 11. For such as network architecture, the downlink CC(s) used by the mobile communications device 300 may be allocated by one coordinated cell (such as the coordinated cell 1) or allocated and coordinated by multiple coordinated cells (such as the coordinated cells 1 to N). When detecting occurrence of an RLF on one or more of the coordinated CCs, the mobile communications device 300 needs to report the information of the RLF, and also the information of the coordinated cell which has allocated the malfunctioned coordinated CC(s). In one embodiment, the reserved fields in Table 3 to Table 5 may be used to indicate the coordinated cell which has allocated the malfunctioned coordinated CC(s). Thus, the RLF reporting methods as described with respect to FIG. 4 to FIG. 10 may be applied to the CoMP network.

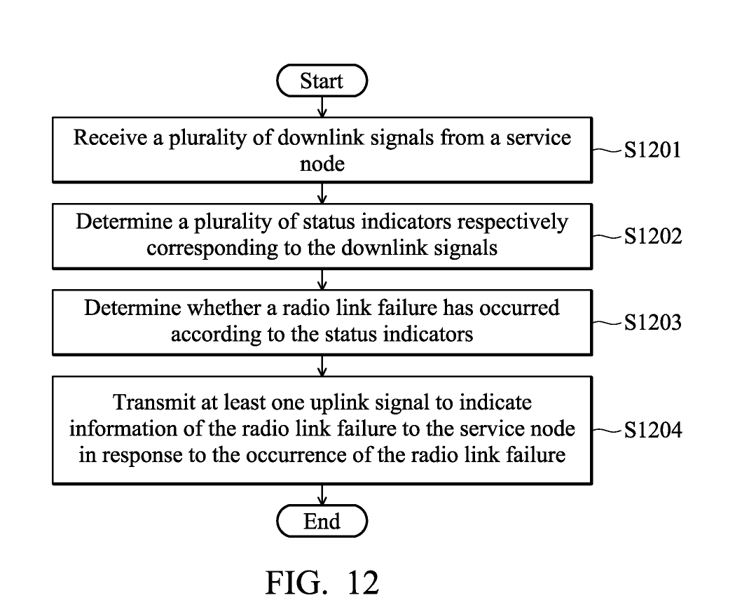

FIG. 12 is a flow chart illustrating the RLF reporting method according to an embodiment of the invention. In this embodiment, the RLF reporting method may be applied in any mobile communications device supporting multiple CCs, so that the mobile communications device may report the information of an RLF to the service node when detecting the occurrence of the RLF and the service node may avoid using the malfunctioned CC(s) to transmit data. Take the mobile communications device 300 for example. To begin, the mobile communications device 300 receives a plurality of downlink signals from the service node 30 (step S1201), and then determines a plurality of status indicators respectively corresponding to the downlink signals (step S1202). Next, the mobile communications device 300 determines whether an RLF has occurred according to the status indicators (step S1203). If so, the mobile communications device 300 transmits at least one uplink signal to indicate the information of the RLF to the service node 30 (step S1204). Since the mobile communications device 300 supports multiple CCs, the downlink channels may be divided into a plurality of CCs in difference frequencies, and the information of the RLF indicates which one or more of the CCs that the RLF has occurred on. Regarding the configuration concerning the information of the RLF, references may be made to the embodiments in FIGS. 4 to 6 if the mobile communications device 300 uses the PUSCH to transmit the uplink signal. If the mobile communications device 300 uses the PUCCH to transmit the uplink signal, reference may be made to the embodiments in FIGS. 8A, 8B, and 9 for the configuration concerning the information of the RLF. If the uplink signal is an SRS, reference may be made to the embodiment in FIGS. 10 for the configuration concerning the information of the RLF.

While the invention has been described by way of example and in terms of preferred embodiment, it is to be understood that the invention is not limited thereto. Those who are skilled in this technology can still make various alterations and modifications without departing from the scope and spirit of this invention. For example, the mobile communications device 300 and the service node 30 may be in compliance with the LTE technology, the 1× CDMA 2000 technology (including the 1× High Rate Packet Data (1× HRPD) Rev A/B/C/D technologies or any evolutionary technologies of the 1× CDMA 2000 technology family), the Worldwide Interoperability for Microwave Access (WiMAX) technology, or other OFDM-based technology. Therefore, the scope of the present invention shall be defined and protected by the following claims and their equivalents.

What is claimed is:

1. A mobile communications device, comprising:
a wireless module receiving a plurality of downlink signals from a service node and determining a plurality of status indicators respectively corresponding to the downlink signals; and
a controller module determining whether a radio link failure has occurred according to the status indicators, and transmitting at least one uplink signal via the wireless module to indicate information of the radio link failure to the service node in response to the occurrence of the radio link failure.

2. The mobile communications device of claim 1, wherein the downlink signals are received on a plurality of component carriers, respectively, and the controller module further determines that the radio link failure has occurred on at least one of the component carriers, wherein the information of the radio link failure comprises information concerning the at least one of the component carriers.

3. The mobile communications device of claim 1, wherein the uplink signal is transmitted on a Physical Uplink Share Channel (PUSCH).

4. The mobile communications device of claim 3, wherein the uplink signal comprises at least one of the following:
a plurality of reference signals; and
a plurality of traffic data signals.

5. The mobile communications device of claim 4, wherein the reference signals are generated according to a plurality of Cyclic Shift (CS) parameters, respectively, and the information of the radio link failure is indicated by a difference between two of the CS parameters.

6. The mobile communications device of claim 1, wherein the uplink signal is transmitted on a Physical Uplink Control Channel (PUCCH), and comprises a plurality of reference signals or control data signals.

7. The mobile communications device of claim 6, wherein the controller module further rotates one of the reference signals for a first phase and rotates another one of the reference signals for a second phase, and the information of the radio link failure is indicated by the first phase and the second phase.

8. The mobile communications device of claim 1, wherein the uplink signal is a Sounding Reference Signal (SRS) transmitted on one or more Orthogonal Frequency Division Multiplexing (OFDM) symbols.

9. The mobile communications device of claim 8, wherein the controller module further rotates a CS parameter for a predetermined phase, and generates the OFDM symbols according to at least one of the following:
the CS parameter;
the rotated CS parameter; and
a CS difference.

10. The mobile communications device of claim 1, wherein the service node comprises at least one of the following:
an evolved Node-B (eNB);
a home eNB (HeNB);
a femtocell;
a relay station; and
a plurality of coordinated cells.

11. A radio link failure reporting method for a mobile communications device supporting multiple component carriers, comprising:
receiving a plurality of downlink signals from a service node;
determining a plurality of status indicators respectively corresponding to the downlink signals;
determining whether a radio link failure has occurred according to the status indicators; and
transmitting at least one uplink signal to indicate information of the radio link failure to the service node in response to the occurrence of the radio link failure.

12. The radio link failure reporting method of claim 11, wherein the downlink signals are received on a plurality of component carriers, respectively, and the radio link failure reporting method further comprises determining that the radio link failure has occurred on at least one of the component carriers, wherein the information of the radio link failure comprises information concerning the at least one of the component carriers.

13. The radio link failure reporting method of claim 11, wherein the uplink signal is transmitted on a Physical Uplink Share Channel (PUSCH).

14. The radio link failure reporting method of claim 13, wherein the uplink signal comprises at least one of the following:
a plurality of reference signals; and
a plurality of traffic data signals.

15. The radio link failure reporting method of claim 14, wherein the reference signals are generated according to a plurality of Cyclic Shift (CS) parameters, respectively, and the information of the radio link failure is indicated by a difference between two of the CS parameters.

16. The radio link failure reporting method of claim 11, wherein the uplink signal is transmitted on a Physical Uplink Control Channel (PUCCH), and comprises a plurality of reference signals or control data signals.

17. The radio link failure reporting method of claim 16, further comprising rotating one of the reference signals for a first phase, and rotating another one of the reference signals for a second phase, wherein the information of the radio link failure is indicated by the first phase and the second phase.

18. The radio link failure reporting method of claim 11, wherein the uplink signal is a Sounding Reference Signal (SRS) transmitted on one or more Orthogonal Frequency Division Multiplexing (OFDM) symbols.

19. The radio link failure reporting method of claim 18, further comprising rotating a CS parameter for a predetermined phase, and generating the OFDM symbols according to at least one of the following:
the CS parameter;
the rotated CS parameter; and
a CS difference.

20. The radio link failure reporting method of claim 11, wherein the service node comprises at least one of the following:
an evolved Node-B (eNB);
a home eNB (HeNB);
a femtocell;
a relay station; and
a plurality of coordinated cells.
